(19) United States
(12) Patent Application Publication
(10) Pub. No.: US 2026/0355763 A1
(43) Pub. Date: Nov. 12, 2026

(54) CLEANING GUN

(71) Applicant: LIH YANN INDUSTRIAL CO., LTD., Taichung City (TW)

(72) Inventor: Po-Lin LIAO, Taichung City (TW)

(21) Appl. No.: 19/205,468

(22) Filed: May 12, 2025

(51) Int. Cl. B05B 9/03

(52) U.S. Cl. CPC B05B 9/035

(57) ABSTRACT

A cleaning gun is provided, wherein the cleaning gun includes: a main body including a chamber; a gun body connected to the main body and including an inlet channel in communication with the chamber; an exhaust channel disposed in the main body and in communication with the chamber and an outside; a guiding channel disposed in the main body and in communication with the inlet channel and the chamber; and a plurality of flow channels disposed in the main body and in communication with the chamber, each of the plurality of flow channels being configured to be selectively in communication with a working assembly.

### BACKGROUND OF THE INVENTION

### Field of the Invention

The present invention relates to a cleaning device, particularly to a cleaning gun.

### Description of the Prior Art

When cleaning, it is common to wet the dirt with a liquid to make it easier to be removed from the object to be cleaned. Accordingly, there is a conventional type of cleaning device that introduces gas into a container and sprays it out after mixing and atomizing the liquid in the container by using pressurized gas and the Venturi effect, enabling a user to spray the liquid onto the object to be cleaned.

However, the conventional cleaning gun mentioned above has a single function and cannot meet the current needs. Therefore, it is necessary to provide a novel and progressive cleaning gun to solve the above issues.

The present invention is, therefore, arisen to obviate or at least mitigate the above-mentioned disadvantages.

### SUMMARY OF THE INVENTION

The main object of the present invention is to provide a cleaning gun that not only includes an exhaust channel to discharge fluid for use but also further includes a plurality of flow channels configured to be assembled with various working assemblies, thereby satisfying diverse usage needs without requirements of purchasing additional cleaning tools.

To achieve the above and other objects, a cleaning gun is provided, wherein the cleaning gun includes: a main body including a chamber; a gun body connected to the main body and including an inlet channel in communication with the chamber; an exhaust channel disposed in the main body and in communication with the chamber and an outside; a guiding channel disposed in the main body and in communication with the inlet channel and the chamber; and a plurality of flow channels disposed in the main body and in communication with the chamber, each of the plurality of flow channels being configured to be selectively in communication with a working assembly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view showing a usage state of an exemplary embodiment of the present invention;

FIG. 2 is a front view of FIG. 1;

FIG. 3 is a partially enlarged cross-sectional view of FIG. 2;

FIG. 4 is an exploded view of an exemplary embodiment of the present invention;

FIG. 5 is a schematic view of another usage state of an exemplary embodiment; and

FIG. 6 is a schematic view of yet another usage state of an exemplary embodiment.

### DETAILED DESCRIPTION OF THE PREFERRED EMBODIMENTS

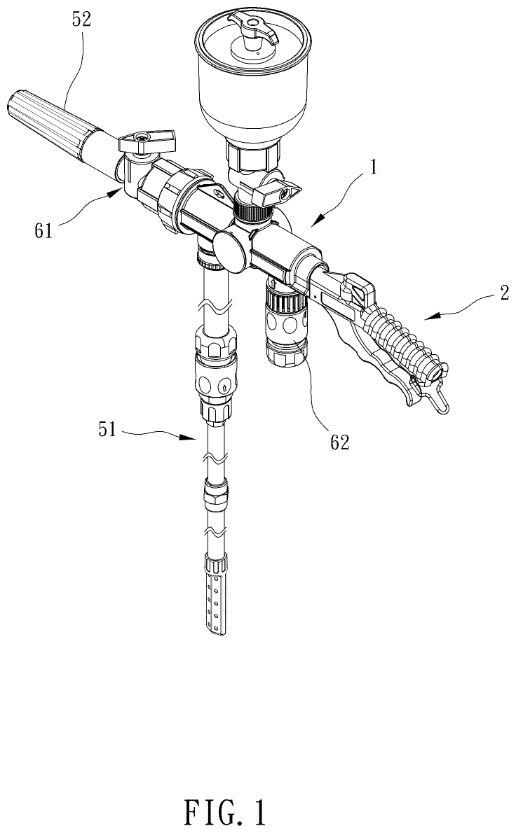

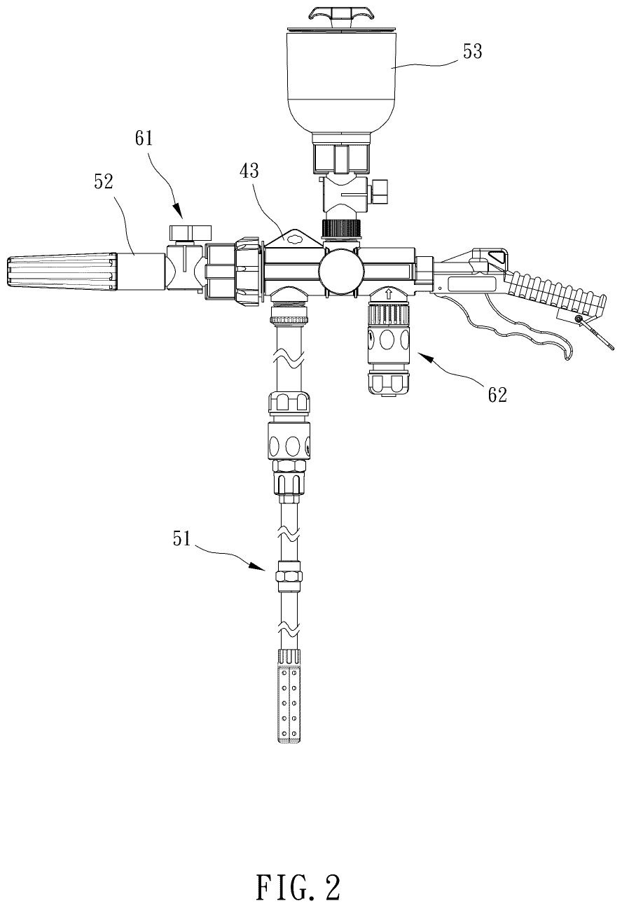

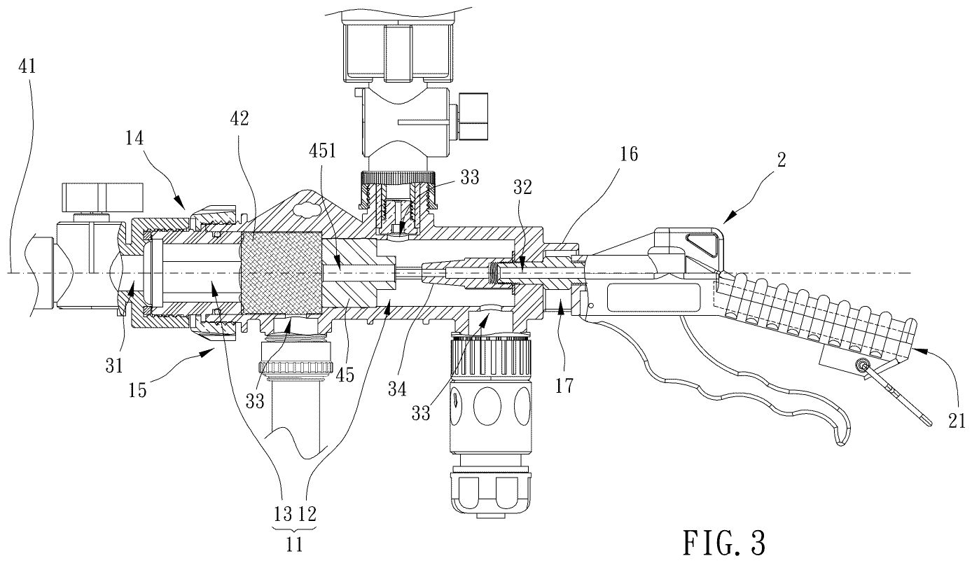

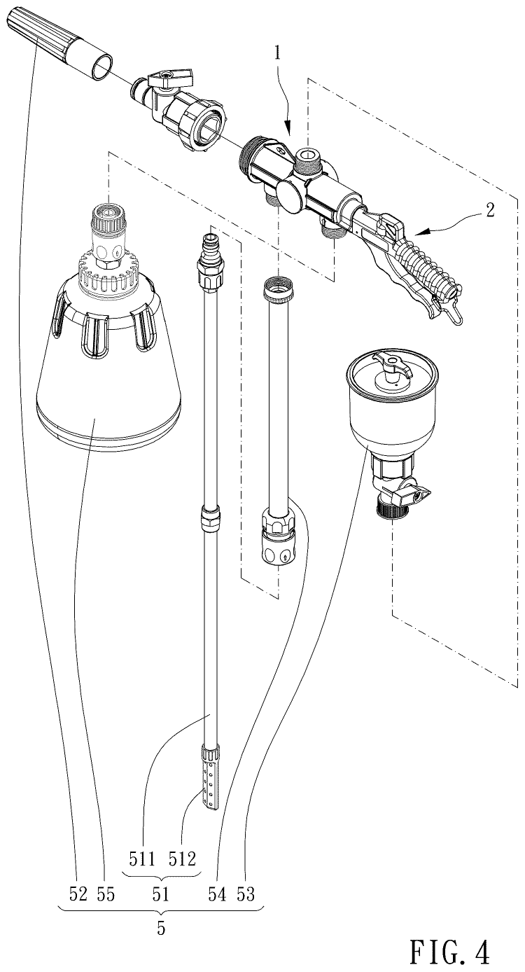

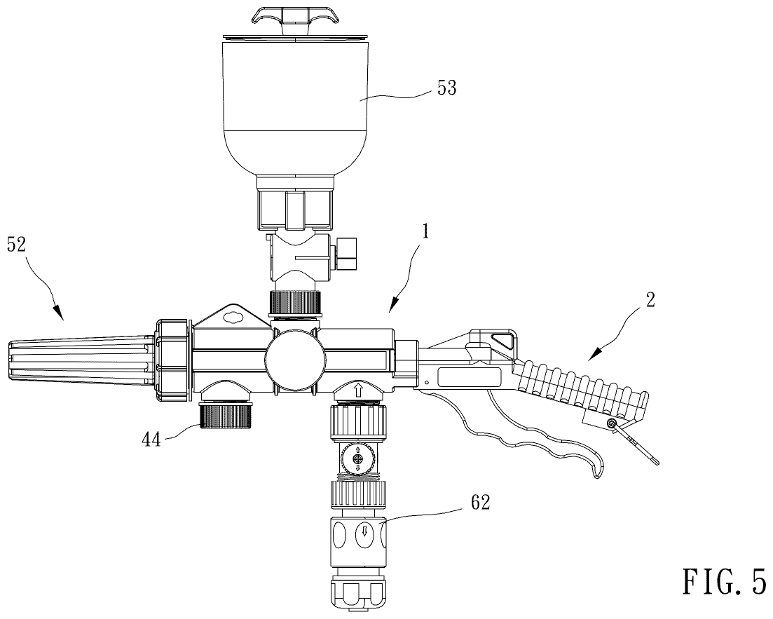

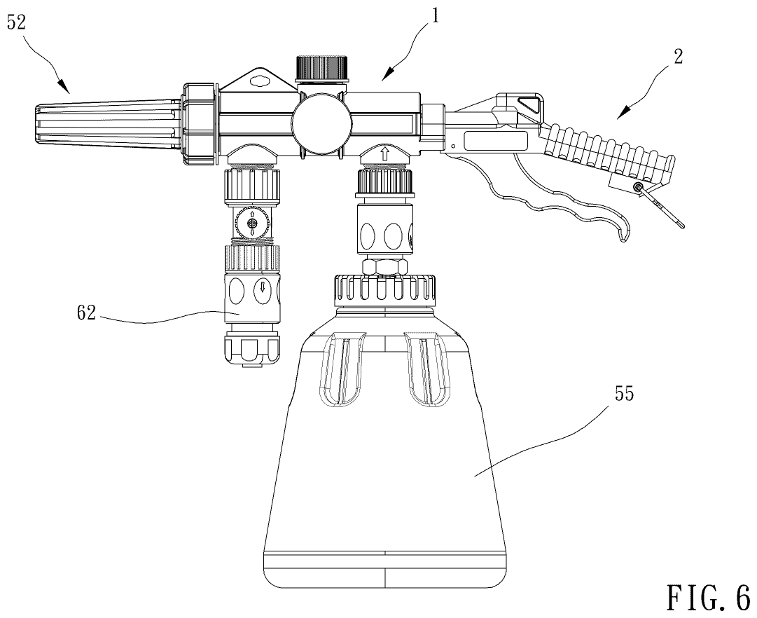

Please refer to FIGS. 1 to 6 for an exemplary embodiment of the present invention. A cleaning gun of the present invention includes a main body 1, a gun body 2, an exhaust channel 31, a guiding channel 32, and a plurality of flow channels 33.

The main body 1 includes a chamber 11. The gun body 2 is connected to the main body 1 and includes an inlet channel 21 in communication with the chamber 11. The exhaust channel 31 is disposed on the main body 1 and is in communication with the chamber 11 and an outside of the cleaning gun. The guiding channel 32 is disposed in the main body 1 and is in communication with the inlet channel 21 and the chamber 11. The plurality of flow channels 33 are disposed in the main body 1 and in communication with the chamber 11. Each of the plurality of flow channels 33 is selectively configured to be in communication with a working assembly 5. As such, the user can install a corresponding working assembly 5 to a selected one of the plurality of flow channels 33 according to different needs, forming different cleaning devices, as will be detailed later.

Preferably, the main body 1 further includes a flange 16 protruding therefrom, the flange 16 defines an internal space 17. The gun body 2 extends into the internal space 17 and is connected to the main body 1. The flange 16 laterally blocks the gun body 2 to prevent its relative rotation, thereby enhancing the coupling stability between the main body 1 and the gun body 2, ensuring that the main body 1 can provide stable support to the working assembly 5 during actual use.

The cleaning gun further includes a first nozzle 34 disposed in the chamber 11 and connected to the main body 1. The first nozzle 34 is in communication with the guiding channel 32. The first nozzle 34 and the exhaust channel 31 are coaxially arranged along a straight reference line 41, thereby ensuring airflow stability and convergence. This configuration helps the chamber 11 maintain a large negative pressure state, enabling suction of fluid from the plurality of flow channels 33 into the chamber 11, followed by mixing and discharge through the exhaust channel 31.

Preferably, the first nozzle 34 is detachably assembled to the main body 1 for cleaning or replacement with different types or sizes.

Specifically, the main body 1 includes an upper portion 14 and a lower portion 15 defined by the straight reference line 41. The plurality of flow channels 33 are disposed in the upper portion 14 and the lower portion 15, respectively, to ensure even distribution. This configuration not only provides sufficient space for installing the working assembly 5 but also allows the user to arrange the assemblies 5 based on personal habits or preferred handling positions.

Specifically, the cleaning gun further includes an intermediate member 45 received in the chamber 11 and dividing the chamber 11 into a first space 12 and a second space 13. The first space 12 is in communication with the guiding channel 32, and the second space 13 is in communication with the exhaust channel 31. The intermediate member 45 includes a communication channel 451 in communication with the first space 12 and the second space 13. At least one of the plurality of flow channels 33 is in communication with the first space 12, and at least one of the plurality of flow channels 33 is in communication with the second space 13.

When the exhaust channel 31 is in communication with the outside, the negative pressure in the first space 12 is greater than that in the second space 13, so that low viscous fluid such as cleaning solutions or chemical agents may be introduced through the plurality of flow channels 33 in communication with the first space 12, providing better suction and mixing effects. High viscous fluid such as water may be introduced through the plurality of flow channels 33 in communication with the second space 13. The user may select different flow channels 33 depending on the fluid type.

Preferably, the number of the flow channels 33 in communication with the first space 12 is greater than the number of the flow channels 33 in communication with the second space 13. In this embodiment, two of the flow channels 33 are disposed in the upper portion 14 and the lower portion 15, respectively, and are in communication with the first space 12 and. Only one of the flow channels 33 is in communication with the second space 13 and is disposed in the lower portion 15. In an extending direction of the straight reference line 41, one of the plurality of flow channels 33 located in the upper portion 14 is positioned between two of the plurality of flow channels 33 located in the lower portion 15 for balanced weight distribution.

The working assembly 5 includes one of a cleaning member 51, a third nozzle 52, an injection barrel 53, a pipeline 54 and a container 55. The user may assemble any of them to one of the flow channels 33 according to usage needs to form a gas-liquid spray gun, foam gun, chemical cleaning gun, air dust gun, and so on.

Preferably, the cleaning gun further includes a plurality of lids 44 each selectively assembled to the main body 1 to seal an unused one of the flow channels 33 and prevent undesired external communication.

Preferably, at least one connector 62 may be selectively assembled to at least one of the flow channels 33 and configured to be connected to the working assembly 5. The user can quickly assemble or detach the working assembly 5 depending on the cleaning requirement. For example, when performing atomization, a hose can be connected via the connector 62, and when only airflow is needed, the hose can be easily detached.

In other embodiments, the cleaning gun may include the cleaning member 51, the third nozzle 52, and a valve 61. Only one of the flow channels 33 is in communication with the second space 13. The cleaning member 51 is assembled to the only one of the flow channels 33. The third nozzle 52 is connected to the main body 1 and in communication with the exhaust channel 31. The valve 61 is disposed between the third nozzle 52 and the exhaust channel 31 and configured to control the communication therebetween. When the valve 61 is turned off, fluid is guided through the flow channel 33 in communication with the second space 13 to the cleaning member 51.

The user can selectively use either the third nozzle 52 or the cleaning member 51 for cleaning. In this embodiment, the cleaning member 51 includes a tube 511 and a second nozzle 512 connected to and in communication with each other. The tube 511 is connected to and in communication with the flow channel 33 and the second space 13. The user can use the third nozzle 52 to clean a surface or use the cleaning member 51 to reach into an interior space (e.g., radiator fins) for cleaning.

Preferably, the cleaning gun further includes a porous member 42 disposed in the chamber 11 and located in the fluid flow path toward the exhaust channel 31. The porous member 42 may be a scouring pad or filter cotton, enables additional mixing of gas-liquid fluids already mixed in the first space 12 to generate more foam before discharging. In this embodiment, the porous member 42 is located in the second space 13 and positioned along the extension directions of the exhaust channel 31 and the flow channel 33 in communication with the second space 13, allowing either the third nozzle 52 or the cleaning member 51 to spray high-quality foam.

Preferably, the cleaning gun further includes a hanging portion 43 disposed on the main body 1 and configured to hang the cleaning gun for convenient storage or freeing the user's hands for other operations.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cleaning gun including:
a main body including a chamber;
a gun body connected to the main body and including an inlet channel in communication with the chamber;
an exhaust channel disposed in the main body and in communication with the chamber and an outside;
a guiding channel disposed in the main body and in communication with the inlet channel and the chamber; and
a plurality of flow channels disposed in the main body and in communication with the chamber, each of the plurality of flow channels being configured to be selectively in communication with a working assembly.

2. The cleaning gun of claim 1, further including a first nozzle disposed connected to the main body, located in the chamber and in communication with the guiding channel, wherein the first nozzle and the exhaust channel are coaxially arranged along a straight reference line.

3. The cleaning gun of claim 2, wherein the main body includes an upper portion and a lower portion defined by the straight reference line, and the plurality of flow channels are disposed in the upper portion and the lower portion, respectively.

4. The cleaning gun of claim 1, further including a porous member received in the chamber, wherein the porous member is located in a flow path of fluid flowing toward the exhaust channel.

5. The cleaning gun of claim 1, further including a hanging portion disposed on the main body and configured to hang the cleaning gun.

6. The cleaning gun of claim 1, further including a plurality of lids each selectively disposed on the main body to close one of the plurality of flow channels.

7. The cleaning gun of claim 1, further including an intermediate member received in the chamber and dividing the chamber into a first space and a second space, wherein the first space is in communication with the guiding channel, the second space is in communication with the exhaust channel, the intermediate member includes a communication channel in communication with the first space and the second space, at least one of the plurality of flow channels is in communication with the first space, and at least one of the plurality of flow channels is in communication with the second space.

8. The cleaning gun of claim 7, wherein the number of the plurality of flow channels in communication with the first space is greater than the number of the plurality of flow channels in communication with the second space.

9. The cleaning gun of claim 7, further including a cleaning member, a third nozzle and a valve, wherein only one of the plurality of flow channels is in communication with the second space, the cleaning member is in communication with the flow channel and the second space, the third nozzle is connected to the main body and in communication with the exhaust channel, the valve is disposed between the third nozzle and the exhaust channel and configured to control communication therebetween, when the valve blocks the communication between the third nozzle and the exhaust channel, fluid flows through the flow channel in communication with the second space to the cleaning member.

10. The cleaning gun of claim 3, further including a porous member, a hanging portion, a plurality of lids, an intermediate member, a cleaning member, a third nozzle and a valve, the porous member is received in the chamber and located in a flow path of fluid flowing toward the exhaust channel, the hanging portion is disposed on the main body to hang the cleaning gun, the lids are each selectively disposed on the main body to close one of the plurality of flow channels, the intermediate member is received in the chamber and divides the chamber into a first space and a second space, the first space is in communication with the guiding channel, the second space is in communication with the exhaust channel, and the intermediate member includes a communication channel in communication with the first space and the second space; at least one of the plurality of flow channels is in communication with the first space, and at least one of the plurality of flow channels is in communication with the second space; the number of the plurality of flow channels in communication with the first space is greater than the number of the plurality of flow channels in communication with the second space; only one of the plurality of flow channels is in communication with the second space, the cleaning member is in communication with the flow channel and the second space, and the third nozzle is connected to the main body and in communication with the exhaust channel, the valve is disposed between the third nozzle and the exhaust channel and configured to control communication therebetween; when the valve blocks the communication between the third nozzle and the exhaust channel, fluid flows through the flow channel in communication with the second space to the cleaning member; the working assembly includes one of the cleaning member, the third nozzle, an injection barrel, a pipeline and a container; at least one connector is selectively assembled to be in communication with at least one of the plurality of flow channels and configured to be connected to the working assembly; the first nozzle is detachably assembled to the main body; the number of the plurality of flow channels in communication with the first space is two, and the plurality of flow channels are disposed in the upper portion and the lower portion, respectively; only one of the plurality of flow channels is in communication with the second space and is disposed in the lower portion; in an extending direction of the straight reference line, one of the plurality of flow channels located in the upper portion is positioned between two of the plurality of flow channels located in the lower portion; the porous member is received in the second space, and the porous member is located in an extending direction of the exhaust channel and in an extending direction of the flow channel in communication with the second space; the cleaning member includes a tube and a second nozzle connected to and in communication with each other, the tube is connected to the flow channel in communication with the second space; the main body further includes a flange protruding therefrom, the flange defines an internal space, the gun body extends within the internal space and is connected to the main body, and the flange laterally blocks the gun body to prevent the gun body from rotating relative thereto.
